(19) United States
(12) Patent Application Publication
(10) Pub. No.: US 2021/0031547 A1
(43) Pub. Date: Feb. 4, 2021

(54) INKJET PRINTING APPARATUS AND CONTROL METHOD THEREOF

(71) Applicant: CANON KABUSHIKI KAISHA, Tokyo (JP)

(72) Inventors: Masataka Kato, Yokohama-shi (JP); Kazuhiko Sato, Tokyo (JP); Kazuo Suzuki, Yokohama-shi (JP); Toshimitsu Danzuka, Tokyo (JP); Yasunori Fujimoto, Inagi-shi (JP); Shin Genta, Yokohama-shi (JP); Kazuki Narumi, Komae-shi (JP); Tomoki Yamamuro, Kawasaki-shi (JP); Hiroto Kango, Tokyo (JP)

(21) Appl. No.: 16/937,416

(22) Filed: Jul. 23, 2020

(30) Foreign Application Priority Data
Jul. 30, 2019 (JP) 2019-140192

(51) Int. Cl. B41J 25/00

(52) U.S. Cl. CPC B41J 25/006

(57) ABSTRACT

An inkjet printing apparatus, comprising a printing head, a carriage having the printing head, a first roller pair disposed upstream of the printing head and configured to nip and convey a printing medium, a second roller pair disposed downstream of the printing head and configured to nip and convey a printing medium, a first ink receiver disposed inside a printing region and configured to receive an ink from the printing head, and a second ink receiver disposed outside the printing region and configured to receive an ink from the printing head, wherein the printing head performs preliminary discharge on the first ink receiver in a first nip state, and performs preliminary discharge on the second ink receiver in a second nip state.

### BACKGROUND

### Field of the Disclosure

The present disclosure relates to an inkjet printing apparatus configured to discharge ink to print an image and a control method thereof.

### Description of the Related Art

Japanese Patent Laid-Open No. 2012-45848 discloses a printing apparatus configured to perform preliminary discharge, from a printing head, on an ink receiving unit provided in a platen and on a maintenance unit provided outside a printing region. Regarding an ink that is likely to accumulate, preliminary discharge is performed on the maintenance unit to prevent such an ink from accumulating on the platen over which a sheet passes.

However, when preliminary discharge is performed during the printing of the leading edge or the trailing edge of a small sheet, the sheet is likely to float up, and preliminary discharge is thereby not performed on the maintenance unit. This is because, if a carriage is moved to a position facing the maintenance unit, the carriage is to be moved to the outside of a region in which the carriage and the sheet face each other, and the carriage may come into contact with the floating-up sheet when returning from the maintenance unit to the region in which the carriage and the sheet face each other.

That is, preliminary discharge involving such movement of the carriage to the maintenance unit is not allowed to be performed and the carriage is moved within the region in which the carriage and the sheet face each other; thus, it is possible to prevent conveyance failure of the sheet and damage to the printing head due to such contact between the floating-up sheet and the carriage.

However, there may be a case in which the configuration disclosed in Japanese Patent Laid-Open No. 2012-45848 cannot sufficiently suppress adhesion of the ink because preliminary discharge is not performed during the printing of the leading edge or the trailing edge of the sheet.

### SUMMARY OF THE INVENTION

The present disclosure has been made considering the above-described possibility and provides an inkjet printing apparatus capable of suppressing discharge failure from occurring even when the leading edge or the trailing edge of a printing medium is printed.

One of the aspects of the present disclosure provides an inkjet printing apparatus, comprising a printing head configured to perform a printing operation in which an image is printed by discharging an ink, a carriage configured to reciprocally move in a first direction with the printing head mounted thereon, a first roller pair disposed upstream of the printing head in a second direction that intersects the first direction and configured to nip and convey a printing medium in the second direction, a second roller pair disposed downstream of the printing head in the second direction and configured to nip and convey a printing medium in the second direction, a first ink receiver disposed inside a printing region in which the printing head performs the printing operation and configured to receive an ink that is discharged from the printing head, and a second ink receiver disposed outside the printing region and configured to receive an ink that is discharged from the printing head, wherein the inkjet printing apparatus performs a first printing sequence in which the printing head performs preliminary discharge on the first ink receiver in a first nip state in which a printing medium is nipped by one of the first roller pair and the second roller pair and the printing head performs preliminary discharge on the second ink receiver in a second nip state in which a printing medium is nipped by both the first roller pair and the second roller pair.

Further features of the present disclosure will become apparent from the following description of exemplary embodiments (with reference to the attached drawings).

### BRIEF DESCRIPTION OF THE DRAWINGS

FIG. 1 is a perspective view of an inkjet printing apparatus according to a first embodiment.

FIG. 2 is a schematic sectional view of a configuration of a conveying unit according to the first embodiment.

FIG. 3 is a perspective view of details of a configuration of a carriage according to the first embodiment.

FIG. 4 is a schematic top view of a state in which, in the inkjet printing apparatus according to the first embodiment, a printing medium is supported by a platen.

FIG. 5 is a block diagram of a configuration of a control system mounted in the inkjet printing apparatus according to the first embodiment.

FIG. 6A is a schematic sectional view of a conveyance state in which a printing medium is conveyed during a printing operation in the inkjet printing apparatus according to the first embodiment.

FIG. 6B is a schematic sectional view of a conveyance state in which the printing medium is conveyed during the printing operation in the inkjet printing apparatus according to the first embodiment.

FIG. 6C is a schematic sectional view of a conveyance state in which the printing medium is conveyed during the printing operation in the inkjet printing apparatus according to the first embodiment.

FIG. 7 is a schematic sectional view of the inkjet printing apparatus according to the first embodiment as viewed from the front.

FIG. 8 is a flowchart of a printing operation sequence including a preliminary discharge operation in the inkjet printing apparatus according to the first embodiment.

FIG. 9 is a flowchart of a printing sequence including a preliminary discharge operation in an inkjet printing apparatus according to a second embodiment.

FIG. 10 is a flowchart of a sequence for selecting a first printing sequence or a second printing sequence to be performed in the inkjet printing apparatus according to the second embodiment.

FIG. 11 is a flowchart of a printing sequence including a preliminary discharge operation in an inkjet printing apparatus according to a third embodiment.

FIG. 12 is a flowchart of a sequence for selecting the first printing sequence or a third printing sequence to be performed in the inkjet printing apparatus according to the third embodiment.

### DESCRIPTION OF THE EMBODIMENTS

Hereinafter, embodiments according to the present disclosure will be described with reference to the drawings. Note that the following embodiments are not intended to limit the present disclosure and that not all combinations of the aspects described in the following embodiments are necessarily for a solution according to the present disclosure. In addition, the relative disposition, the shapes, and the like of the constituents described in the following embodiments are merely examples, and the scope of the present disclosure is not intend to be limited only to the relative disposition, the shapes, and the like of the constituents described in the following embodiments.

### First Embodiment

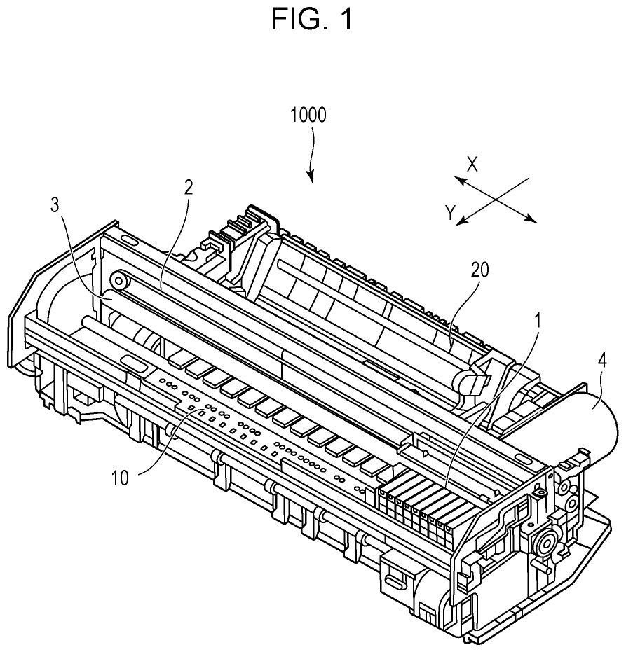

FIG. 1 is a perspective view of an inkjet printing apparatus (hereinafter, referred to as a printing apparatus) 1000, which is applied to the present embodiment, with an interior mechanism thereof exposed by removing an exterior part. A feeding unit 20 has a pressure plate capable of being stacked with a plurality of printing media and is configured to feed a printing medium by a feeding roller (not illustrated). Although a cut sheet is described as an example of the printing medium used in the present embodiment, the printing medium is not limited to such a sheet, and the feeding unit 20 can also be adopted into a configuration for printing a rolled sheet.

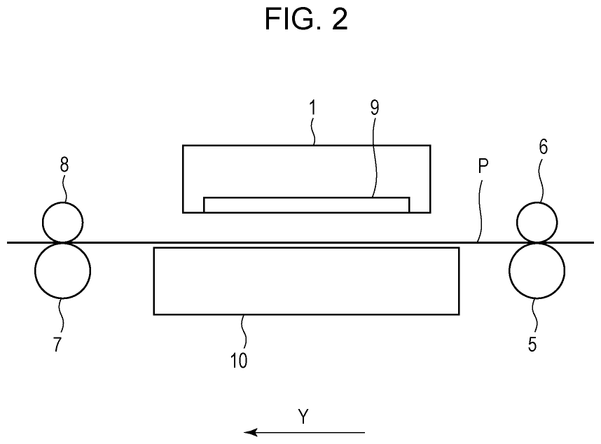

A printing medium that has been fed by the feeding unit 20 is conveyed by a conveying unit including a conveying roller 5, which will be described below, in the Y direction (conveyance direction) to a printing position facing a printing head 9 (refer to FIG. 2) configured to discharge ink. The printing head 9 is mounted in a carriage 1. The carriage 1 reciprocally scans/moves in the X direction (scan direction) intersecting the Y direction along a guide shaft 3 via a timing belt 2 in response to being driven by a carriage motor 4.

When an image for one band has been printed by the carriage 1 moving in the X direction and by the printing head 9 discharging ink, the printing medium is conveyed by the conveying roller 5 and the like only by one band (by a predetermined region) in the Y direction. Such a printing operation in which an ink discharging operation for one band and an intermittent conveying operation are repeated enables images to be printed all over the printing medium. In the present embodiment, the X direction and the Y direction are orthogonal to each other.

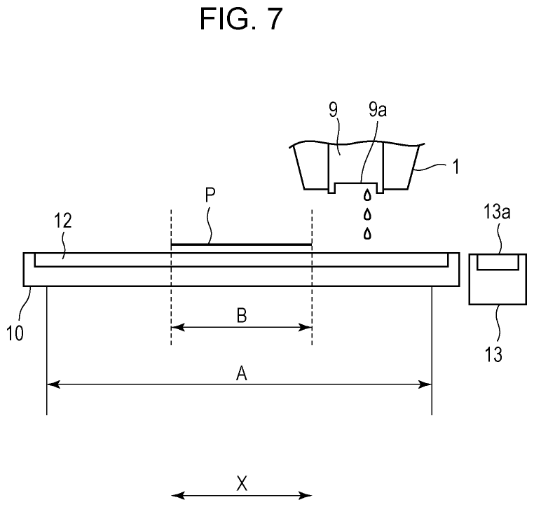

A platen 10 configured to support the printing medium from below is disposed at a position facing the printing head 9 and in a printing region in which the printing head 9 performs printing. The platen 10 serves to maintain a predetermined gap between a printing surface of the printing medium and a discharging port surface 9a (refer to FIG. 7) of the printing head 9 in which discharging ports that discharge ink are aligned.

FIG. 2 is a schematic sectional view of a configuration of the conveying unit of the printing apparatus 1000 as viewed from the right side of the printing apparatus 1000. A printing medium P that has been fed by the feeding unit 20 is conveyed to the printing position facing the printing head 9 while being nipped by the conveying roller 5 and a pinch roller 6 that are disposed upstream of the printing head 9 in the Y direction.

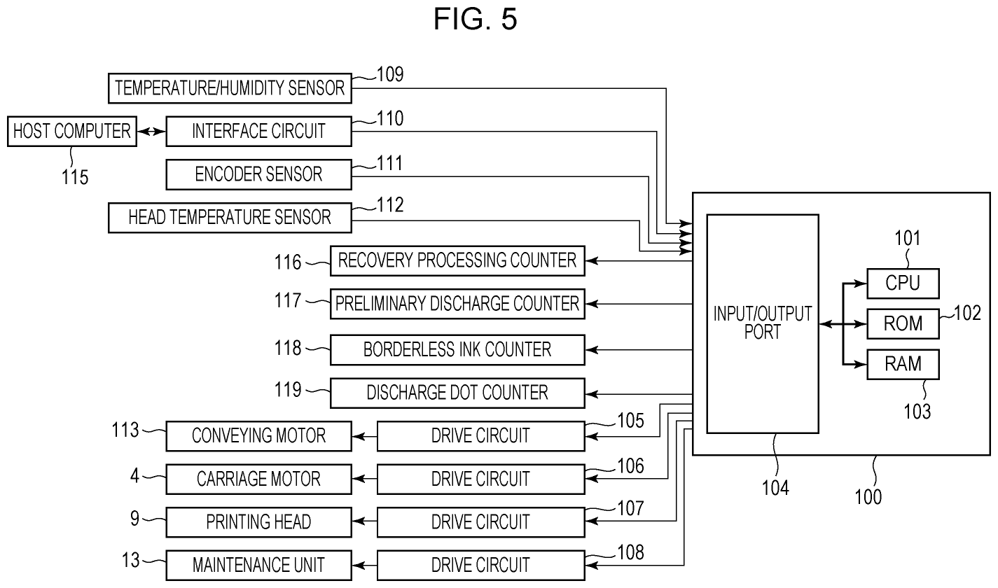

The printing medium P that has been printed by the printing head 9 is discharged to the outside of the printing apparatus while being nipped by a discharging roller 7 and a spur roller 8 that are disposed downstream of the printing head 9 in the Y direction. The conveying roller 5, the pinch roller 6, the discharging roller 7, and the spur roller 8 are also collectively referred to as a conveying unit. The conveying roller 5 and the discharging roller 7 are driven rollers that are synchronously driven by a conveying motor 113 (refer to FIG. 5).

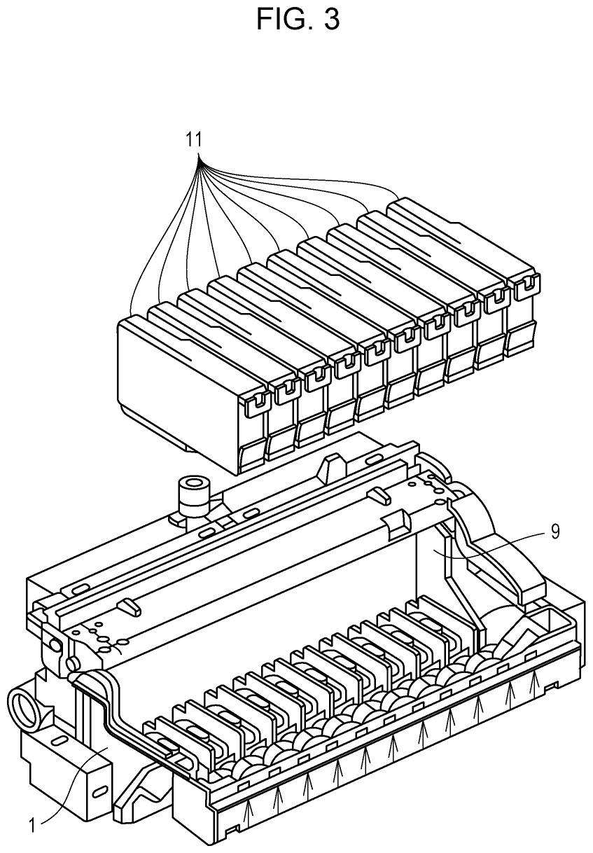

FIG. 3 is a perspective view of details of a configuration of the carriage. The printing head 9 can discharge ten types of inks, and ten types of ink tanks 11 corresponding to the inks are removably mounted in the carriage 1. The printing head 9 can discharge a cyan ink, a magenta ink, a yellow ink, a first black ink, a second black ink, a red ink, a light cyan ink, a light magenta ink, a gray ink, and a clear ink. Such types of inks are examples, and the present disclosure is also applicable to other types of inks.

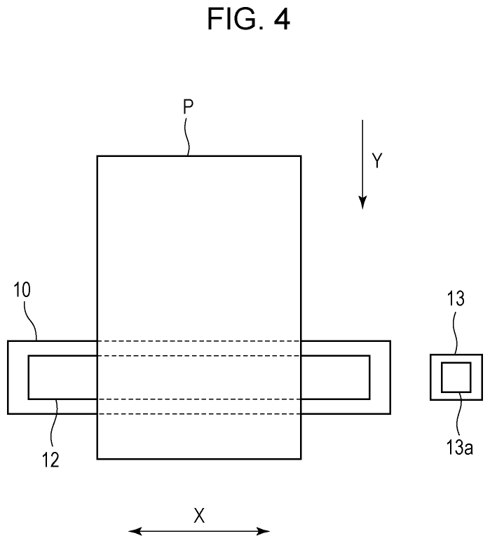

FIG. 4 is a schematic top view of a state in which a printing medium is supported by the platen. The carriage 1 and the printing head 9 are omitted in FIG. 4. A platen absorber 12 capable of absorbing ink that is discharged from the printing head 9 is disposed on an upper surface of the platen 10. The ink that has been absorbed by the platen absorber 12 is collected in a waste ink pack provided in the printing apparatus 1000.

A maintenance unit 13 is disposed at a position outside the printing region in which the platen 10 is disposed and inside a scan region of the carriage 1. The maintenance unit 13 is a unit configured to perform a recovery operation for recovering discharge performance of the printing head 9 and has a cap member 13a capable of covering the discharging port surface 9a and a pump that is connected to the cap member 13a and that generates negative pressure.

The maintenance unit 13 performs a suction operation for forcibly discharging ink from a discharging port by the pump being driven to suck the ink, with the cap member 13a covering the discharging port surface 9a. The ink that has been discharged through the suction operation is collected in the waste ink pack. The maintenance unit 13 further has a wiper capable of wiping the discharging port surface 9a and further performs a wiping operation for wiping the ink that has adhered on the discharging port surface 9a.

When not performing an ink discharging operation (printing operation), the printing head 9 is on standby with the cap member 13a covering the discharging port surface 9a. That is, the position at which the printing head 9 faces the cap member 13a is a standby position (home position) of the printing head 9 or the carriage 1.

Before or during the printing operation, the printing head 9 performs a preliminary discharge operation for discharging ink, which does not contribute to printing, to maintain the ink discharge performance thereof. The preliminary discharge operation is performed at a position at which the discharging port surface 9a of the printing head 9 faces the platen absorber 12 on the platen 10 or a position at which the discharging port surface 9a of the printing head 9 faces the cap member 13a of the maintenance unit 13. That is, each of the platen absorber 12 and the cap member 13a of the maintenance unit 13 functions as an ink receiver configured to receive ink to be discharged through the preliminary discharge operation.

FIG. 5 is a block diagram of a configuration of a control system (controller) mounted in the printing apparatus 1000. Amain control unit 100 includes a central processing unit (CPU) 101 configured to perform processing operations such as calculation, control, determination, and setting and a read-only memory (ROM) 102 configured to store, for example, the control program to be performed by the CPU 101. The main control unit 100 further includes a random-access memory (RAM) 103 that is used, for example, as a buffer that stores printing data of binary values representing discharge and non-discharge of ink and as a work area for processing performed by the CPU 101 and includes an input/output port 104.

The input/output port 104 is coupled to a drive circuit 105 of the conveying motor 113 constituting the conveying unit, a drive circuit 106 of the carriage motor 4, a drive circuit 107 of the printing head 9, and a drive circuit 108 of the maintenance unit 13. The input/output port 104 is further coupled to a head temperature sensor 112 configured to detect the temperature of the printing head 9, an encoder sensor 111 fixed to the carriage 1, and a temperature/humidity sensor 109 configured to detect the temperature and humidity of the printing apparatus 1000 in the operational environment.

The main control unit 100 is further coupled to a host computer 115 via an interface circuit 110. A recovery processing counter 116 is configured to count the amount of the ink that is forcibly discharged from the printing head 9 by the maintenance unit 13. A preliminary discharge counter 117 is configured to count the number of times preliminary discharge is performed before, after, and during the printing operation.

A borderless ink counter 118 is configured to count the amount of the ink that is discharged to the outside of the printing medium when the printing head 9 performs borderless printing in which ink is discharged even to the outside of a printing medium. A discharge dot counter 119 is configured to count the amount of the ink that is discharged during the printing operation.

A printing operation performed in the printing apparatus 1000 having such an above-described control system will be described. When received from the host computer 115 via the interface circuit 110, printing data is expanded in a buffer of the RAM 103. In response to a printing instruction, the conveying unit becomes activated and conveys a printing medium to the printing position facing the printing head 9. The carriage 1 moves in the X direction along the guide shaft 3.

The position of the carriage 1 is detected by the main control unit 100 counting pulse signals output from the encoder sensor 111 along with the movement of the carriage 1. That is, the encoder sensor 111 detects detection portions that are formed in an encoder film (not illustrated), which is disposed in the X direction, at regular spacing, thereby outputting the pulse signals to the main control unit 100. The carriage 1 moves to the standby position and other positions on the basis of the signals from the encoder sensor 111.

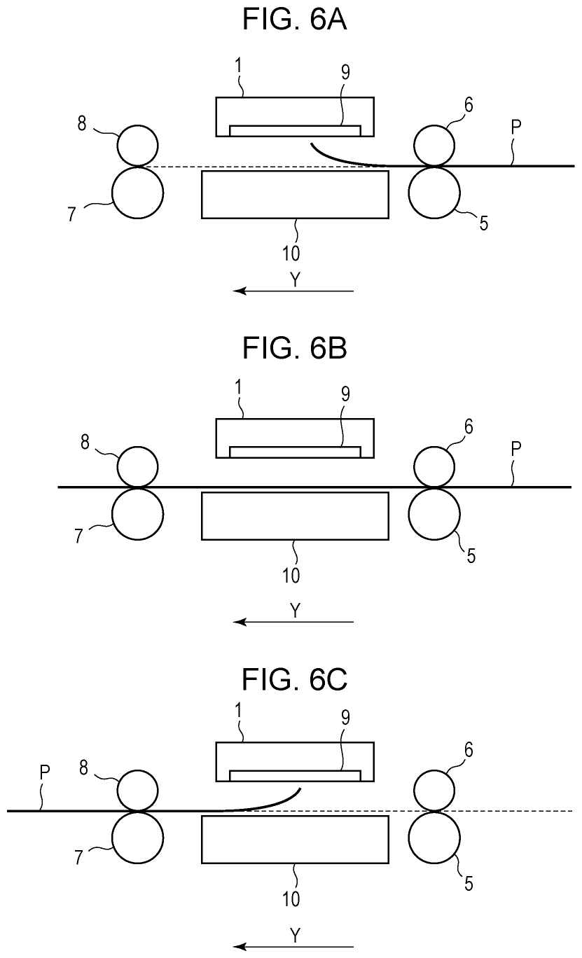

FIGS. 6A to 6C are schematic sectional views of a conveyance state in which a printing medium is conveyed during the printing operation. FIG. 6A illustrates a first state in which a printing medium P that has been conveyed from the upstream side in the Y direction is nipped by the conveying roller 5 and the pinch roller 6 that are provided as a first roller pair. In the first state, the printing medium P is not nipped by the discharging roller 7 and the spur roller 8 that are provided as a second roller pair.

FIG. 6B illustrates a second state in which the printing medium P is further conveyed in the Y direction from the position in the first state of FIG. 6A and is nipped by both the first roller pair and the second roller pair. FIG. 6C illustrates a third state in which the printing medium P is further conveyed from the position in the second state of FIG. 6B and is not nipped by the first roller pair but is nipped only by the second roller pair.

In the present embodiment, the preliminary discharge operation is performed on the cap member 13a of the maintenance unit 13 when the conveyance state is the second state, and the preliminary discharge operation is not allowed to be performed on the cap member 13a when the conveyance state is the first state or the third state.

For example, when the conveyance state is the first state, as FIG. 6A illustrates, the leading edge of the printing medium P is likely to float up with respect to the platen 10 because the printing medium P is nipped only by the first roller pair. After the carriage 1 is moved to the maintenance unit 13 and performs the preliminary discharge operation with the printing medium P floating up, there may be a case in which the leading edge of the printing medium P abuts the carriage 1 or the printing head 9 when the carriage 1 returns from the maintenance unit 13 to the printing region. Such abutment may cause conveyance failure due to a bend of the printing medium P and may damage the printing head 9.

Similarly, when the conveyance state is the third state, as FIG. 6C illustrates, the trailing edge of the printing medium P is likely to float up with respect to the platen 10 because the printing medium P is nipped only by the second roller pair. Thus, such floating-up of the printing medium P may cause conveyance failure and may damage the printing head 9.

Due to the above-described circumstances, in the present embodiment, a moving range of the carriage 1 is limited in the first state or the third state in which the conveyance state is a “one-side nip state”. That is, the carriage 1 is controlled not to move to the standby position. A state in which the conveyance state is the second state is also referred to as a “both-sides nip state”.

FIG. 7 is a schematic sectional view of the printing apparatus 1000 as viewed from the front. The region A denotes a region (printing region) through which a printing medium having a maximum printable width of the printing apparatus 1000 of the present embodiment passes. The region B denotes the width of the printing medium P (passing region) in which the printing head 9 illustrated in FIG. 7 performs the printing operation.

The printing apparatus 1000 adopts a center reference method in which the printing medium P is conveyed with reference to the center thereof in the X direction. That is, the printing apparatus 1000 conveys printing media P so that the center position of each printing medium P in the X direction passes through the same position. Consequently, the moving distance of the carriage 1 from an edge portion of a printing medium to the maintenance unit 13 increases as the width of the printing medium decreases.

For example, when the preliminary discharge operation is performed on the maintenance unit 13 during the printing operation of the printing medium P illustrated in FIG. 7, the carriage 1 is required to move to the outside of the region B. At this time, even if the printing medium P floats up, by the carriage 1 reciprocally scanning so that at least a portion of the carriage 1 is within the region B, the floating-up printing medium P is in contact with a lower surface of the carriage 1 or the printing head 9, thereby being enabled to be held down. Thus, it is possible to suppress the printing medium P from bending.

The discharging port surface 9a of the printing head 9 is disposed on the upper side of a lower surface constituting a lowest portion of the printing head 9, thereby being unlikely to come into contact with the floating-up printing medium P.

Thus, if a printing medium is likely to float up, that is, if the conveyance state is the first state or the third state, the carriage 1 reciprocally scans in the X direction so that at least a portion of the carriage 1 is in the passing region of the printing medium P. In other words, the carriage 1 reciprocally scans so that the entire carriage 1 does not pass beyond the passing region of the printing medium P. Thus, the carriage 1 does not move to the standby position facing the maintenance unit 13 and does not perform the preliminary discharge operation.

On the other hand, when the conveyance state is the second state, the printing medium is unlikely to float up because the printing medium is nipped by both the first roller pair and the second roller pair. Thus, the carriage 1 moves to the standby position facing the maintenance unit 13 and performs the preliminary discharge operation.

When the conveyance state is the first state or the third state, a printing medium may or not float up in accordance with the type and the size of the printing medium. For example, in a case in which a printing medium is plain paper, the printing medium is likely to float up because plain paper has low rigidity. However, a printing medium having rigidity higher than plain paper is unlikely to float up. In a case of a printing medium having a small width, such a printing medium is likely to float up compared with a case of a printing medium having a large width.

In addition, in a case in which a printing medium is paper, the paper is swollen and deforms due to the action of moisture in ink, which has been discharged, on fibers of the printing medium. Moreover, through the process of drying of the swollen paper, the paper shrinks and deforms. Thus, ease of occurrence of floating-up varies in accordance with the amount of the ink to be discharged.

The second black ink among the inks that the printing head 9 can discharge is likely to adhere and be thickened because the second black ink has a high concentration and contains abundant solid components compared with the first black ink. In a case in which the second black ink is discharged on the platen absorber 12, because the second ink is likely to adhere to and accumulate on the absorber, the ink that has accumulated thereon may stain the printing medium P to be conveyed. Thus, preliminary discharge of the second black ink can be performed on the cap member 13a of the maintenance unit 13 instead of the platen absorber 12. The second black ink that has been discharged on the cap member 13a is forcibly discharged into the waste ink pack by the pump (not illustrated).

Regarding the inks other than the second black ink, there is no need to place restrictions on performing of the preliminary discharge operation on the platen absorber 12 because the inks other than the second black ink are unlikely to adhere compared with the second black ink. Thus, it is possible to perform the preliminary discharge operation on the platen absorber 12 that is away from an edge portion of the printing medium by a predetermined distance in accordance with the width of the printing medium in the X direction.

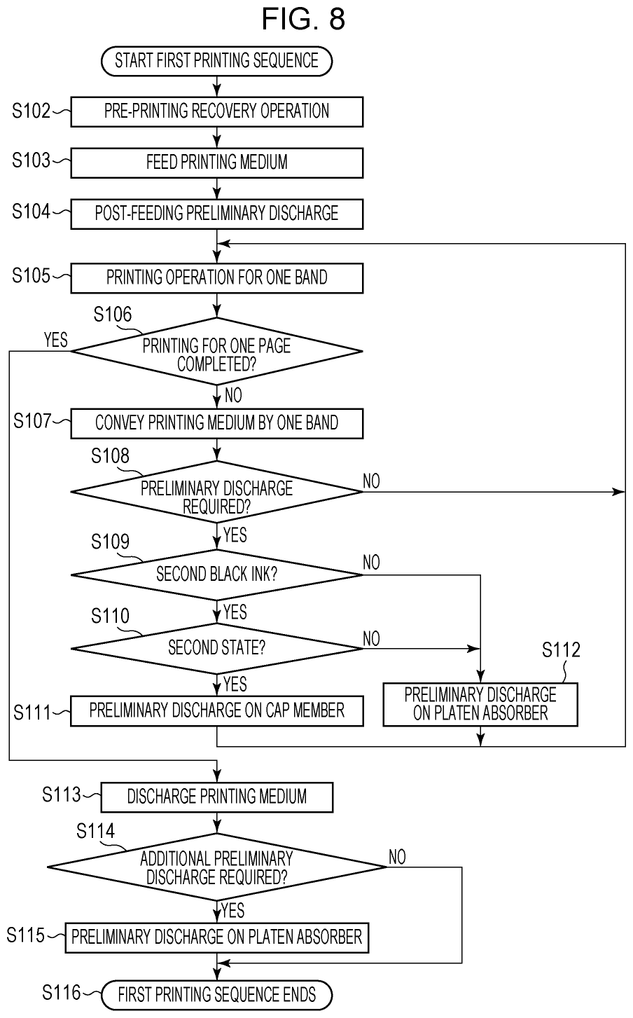

FIG. 8 is a flowchart of a printing operation sequence including a preliminary discharge operation. In S101, when the printing apparatus 1000 receives printing data, a first printing sequence is started.

In S102, the CPU 101 performs a pre-printing recovery operation. In the present embodiment, for example, a preliminary discharge operation of 500 shots from each discharging port is performed on the cap member 13a. The number of times of preliminary discharge at this time is determined on the basis of the elapsed time from the previous printing operation and is set so as to increase as the elapsed time increases. However, the setting is not limited to the above configuration, and a configuration in which the recovery operation to be performed is determined, for example, on the basis of the capping time during which the cap member 13a covers the printing head 9 may also be possible.

In S103, the CPU 101 allows the feeding unit 20 to feed a printing medium and allows the conveying roller 5 and the pinch roller 6, which are the first roller pair, to nip the printing medium. That is, a feeding operation of the printing medium in S103 causes the conveyance state to be the first state.

In S104, the CPU 101 allows the printing head 9 to perform a post-feeding preliminary discharge operation. Such preliminary discharge is for recovering the discharge performance of the printing head 9 that has been lowered while the feeding operation in S103 is performed. In the present embodiment, a preliminary discharge operation of 100 shots from each discharging port is performed on the cap member 13a.

In a case in which a printing medium is plain paper, the printing medium is unlikely to float up before the ink is discharged. Thus, even if the carriage 1 is moved to the standby position to perform the preliminary discharge operation in S104, the carriage 1 and the printing medium are unlikely to abut each other.

In S105, the CPU 101 allows the printing head 9 to perform a printing operation for one band while allowing the carriage 1 to move in the X direction. Thereafter, in S106, the CPU 101 determines whether the printing for one page has been completed. If the printing has not been completed, a conveying operation by one band is performed in S107.

Next, in S108, the CPU 101 performs the necessity determination of the preliminary discharge operation. The determination is made on the basis of whether the elapsed time from the previous preliminary discharge operation is above a threshold on an ink type basis. Regarding all the types of inks, if the elapsed time from the previous preliminary discharge operation is below the threshold, the process returns to S105. In the present embodiment, although the threshold is set uniformly to two seconds, various thresholds may be set in accordance with the type of ink. In addition, a configuration in which the preliminary discharge operation is performed every time a printing operation for the predetermined number of bands ends may be adopted.

On the other hand, if the elapsed time from the previous preliminary discharge operation is above the threshold, the process proceeds to S109, and the CPU 101 determines whether the ink for which the preliminary discharge operation is required is the second black ink. If the ink for which the preliminary discharge operation is to be performed is an ink other than the second black ink, the process proceeds to S112, and the printing head 9 performs the preliminary discharge operation on the platen absorber 12 at a position away from an edge portion of the printing medium by a predetermined distance in the X direction. For example, a preliminary discharge of 16 shots is performed here.

On the other hand, if the ink for which the preliminary discharge operation is required is the second black ink, the process proceeds to S110, and whether the conveyance state is the second state is determined. In the present embodiment, the conveyance state is determined on the basis of a sensor that is disposed upstream of the printing head 9 and that can detect an edge portion of the printing medium and on the basis of the rotation amount of the feeding roller.

In S110, if it is determined that the conveyance state is the second state, the process proceeds to Sll1, the carriage 1 is moved to the position facing the maintenance unit 13, and preliminary discharge is performed on the cap member 13a from the printing head 9. When the conveyance state is the second state, the printing medium is unlikely to float up, and preliminary discharge is thereby performed on the cap member 13a to suppress the second black ink from accumulating on the platen absorber 12.

On the other hand, in Sl10, if it is determined that the conveyance state is not the second state, that is, the conveyance state is the first state or the third state, the process proceeds to S112, and preliminary discharge is performed on the platen absorber 12 from the printing head 9. As described above, when the conveyance state is the first state or the third state, the printing medium is likely to float up, and the preliminary discharge operation is thereby performed on the platen absorber 12, even if the second black ink is discharged. In the present embodiment, the number of shots of preliminary discharge of the second black ink during the printing operation is set to 8 in both cases of preliminary discharge on the platen absorber 12 and preliminary discharge on the cap member 13a.

In S111, when the preliminary discharge operation of the second black ink is performed on the cap member 13a and even if the necessity determination of the preliminary discharge operation of another ink is “no”, the preliminary discharge operation thereof may be performed on the cap member 13a at the same timing as the preliminary discharge operation of the second black ink.

After the process returns to S105, when the printing for one page has been completed, the process proceeds to S113, and the printing medium is discharged to the outside of the printing apparatus by the discharging roller 7.

The process then proceeds to S114, and whether additional preliminary discharge is required is determined. That is, regarding the determination in S114, whether preliminary discharge of the second black ink has been performed on the platen absorber 12 in S112 is determined. Because the second black ink is likely to accumulate, preliminary discharged of an ink, other than the second black ink, that is unlikely to accumulate is performed additionally on a region of the platen absorber 12 on which preliminary discharge of the second black ink has been performed. Such an operation is also referred to as an additional preliminary discharge operation.

Thus, if it is determined that the additional preliminary discharge operation is required, in S115, the additional preliminary discharge operation is performed on the region of the platen absorber 12 on which preliminary discharge of the second black ink has been performed. In S116, the first printing sequence ends.

In the present embodiment, for example, preliminary discharge of the clear ink is performed additionally in an amount three times as large as the amount of the second black ink that has been discharged during preliminary discharge. The additional preliminary discharge operation can suppress the second black ink from accumulating and adhering to a discharge path to the waste ink pack.

The necessity determination of additional preliminary discharge in S114 may alternatively be made on the basis of the preliminary discharge amount of the second black ink and another ink in the platen absorber 12. That is, if the preliminary discharge amount of another ink is larger than the preliminary discharge amount of the second black ink by a predetermined amount, an accumulation suppressing effect can be achieved, and it is thereby possible to make a determination that the additional preliminary discharge operation is not required.

As described above, regarding the second black ink, preliminary discharge on the cap member 13a and preliminary discharge on the platen absorber 12 are switched on the basis of the conveyance state of the printing medium. Thus, preliminary discharge of the second black ink can be performed regardless of the conveyance state, and discharge failure can be suppressed from occurring when the leading edge or the trailing edge of the printing medium is printed. In addition, when preliminary discharge has been performed on the platen absorber 12, the second black ink can be suppressed from accumulating on the platen absorber 12 by performing the additional preliminary discharge operation after the printing has been finished.

### Second Embodiment

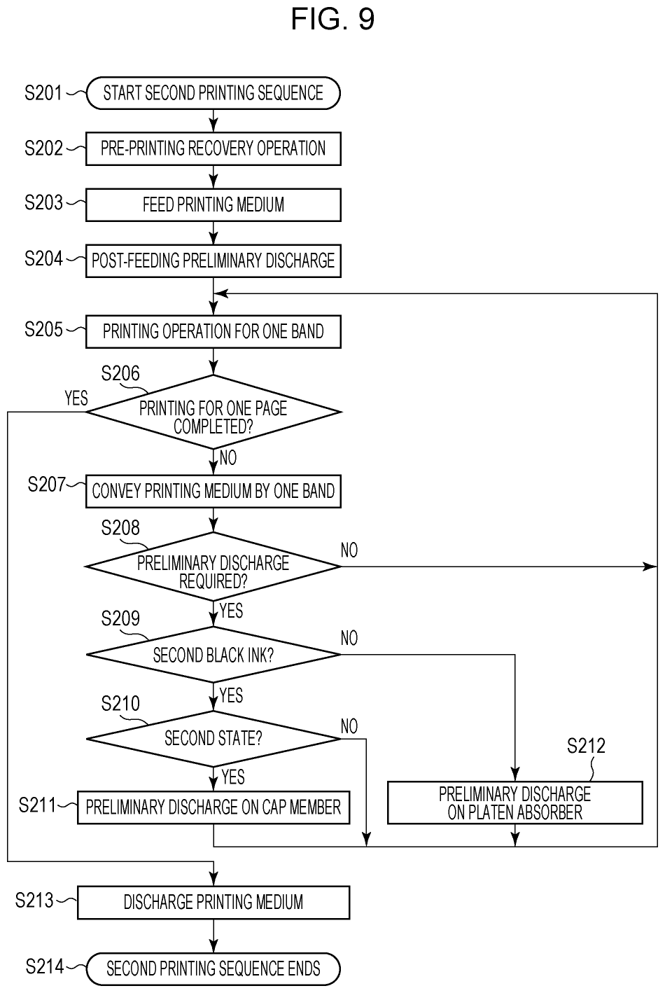

FIG. 9 is a flowchart of a printing sequence including a preliminary discharge operation in a second embodiment. The printing sequence illustrated in FIG. 9 is referred to as a second printing sequence. An apparatus configuration and the like here are similar to those of the first embodiment, and points different from the first printing sequence will be described mainly hereinafter. In S201, when the printing apparatus 1000 receives printing data, the second printing sequence is started. Hereinafter, S202 to S209 are similar to S102 to S109 of the first printing sequence illustrated in FIG. 8, and the description of S202 to S209 will thus be omitted.

In S210, when the preliminary discharge operation of the second black ink is required and if the conveyance state of a printing medium is the second state, preliminary discharge is performed on the cap member 13a as with the first printing sequence.

On the other hand, in S210, if the conveyance state is not the second state, that is, the conveyance state is the first state or the third state, the preliminary discharge operation of the second black ink is not performed, and the process returns to S205. Thus, preliminary discharge of the second black ink is not performed on the platen absorber 12.

After the printing medium is discharged in S213, the second printing sequence ends in S214. That is, after the printing medium is discharged, the preliminary discharge operation is not performed on the platen absorber 12.

As described above, in the second printing sequence, the preliminary discharge operation of the second black ink is not performed when the conveyance state is the first state or the third state. This is because it is assumed that the printing apparatus is used, for example, in a printing mode in which suppression of ink consumption has higher priority than printing quality. That is, the additional preliminary discharge operation is not performed in the second printing sequence, and it is thereby possible to reduce the amount of waste ink compared with that in the first printing sequence.

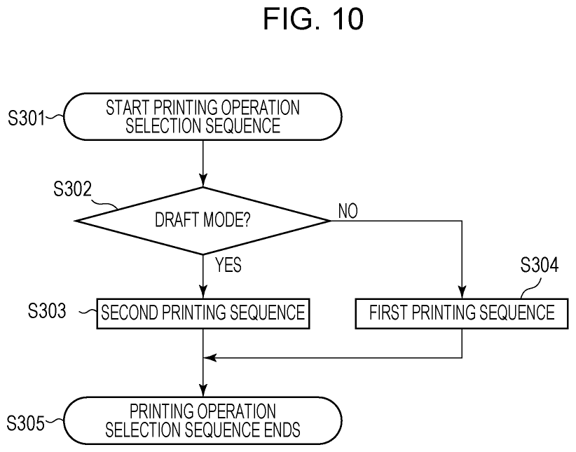

FIG. 10 is a flowchart of a sequence for selecting the first printing sequence or the second printing sequence to be performed. In S301, when the printing apparatus 1000 receives printing data, a printing operation selection sequence is started before a printing sequence is started.

In S302, the CPU 101 determines whether the printing mode is a draft mode. The draft mode is a mode in which “single-path printing” in which the printing head 9 completes a printing operation on a region for one band by moving with the carriage 1 in one direction is performed. That is, the draft mode is a mode in which printing speed has higher priority than printing quality. As a mode other than the draft mode, for example, a high-quality mode is available. In the high-quality mode, “multi-path printing” in which the printing head 9 completes the printing operation on the region for one band by reciprocating with the carriage 1 is performed. The carriage 1, for example, performs eight scans for the multi-path printing.

If the printing mode is the draft mode, the CPU 101 selects the second printing sequence (S303). On the other hand, if the printing mode is not the draft mode (for example, the printing mode is the high-quality mode), the CPU 101 selects the first printing sequence (S304). In S305, the printing operation selection sequence ends.

Thus, in the second embodiment, it is possible to perform an appropriate printing sequence capable of reducing the amount of waste ink while printing quality is maintained by switching between such flows related to preliminary discharge operation of the second black ink when the conveyance state is the first state or the third state.

Although the printing modes are distinguished from each other on the basis of the number of scans required to complete the region for one band, a way to distinguish the printing modes is not limited to such a way, and it is also possible to adopt a way in which the printing modes are distinguished from each other on the basis of the scan speed of the carriage 1. That is, a mode in which the scan speed of the carriage 1 is fast may be the draft mode, and a mode in which the scan speed thereof is slow may be the high-quality mode.

### Third Embodiment

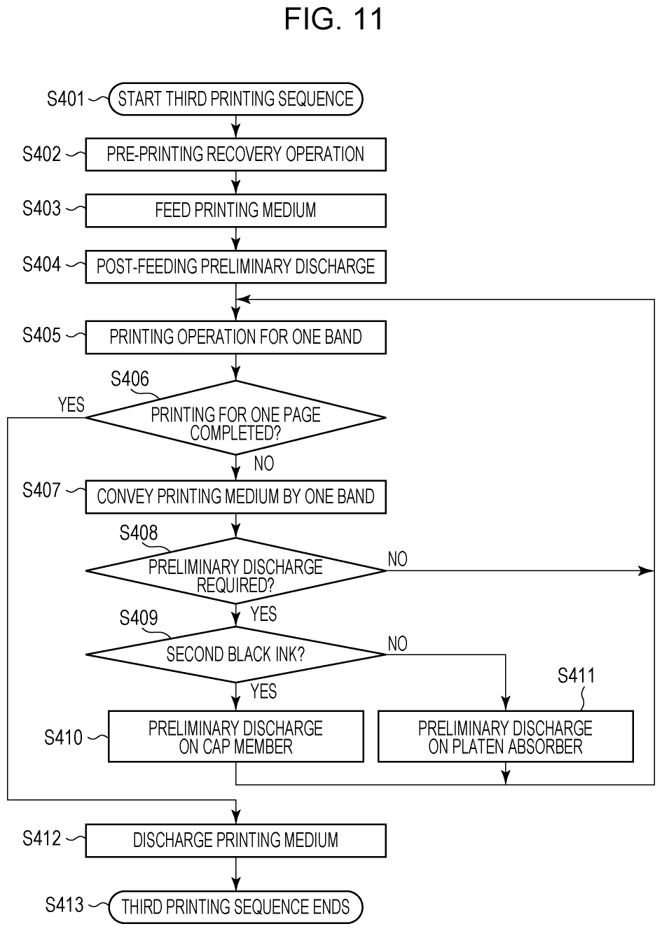

FIG. 11 is a flowchart of a printing sequence including a preliminary discharge operation in a third embodiment. The printing sequence illustrated in FIG. 11 is referred to as a third printing sequence. An apparatus configuration and the like here are similar to those of the first embodiment and the second embodiment, and points different from the first printing sequence and the second printing sequence will be described mainly hereinafter. In S401, when the printing apparatus 1000 receives printing data, the third printing sequence is started. Hereinafter, S402 to S408 are similar to S102 to S108 of the first printing sequence illustrated in FIG. 8, and the description of S402 to S408 will thus be omitted.

In S409, if the preliminary discharge operation of the second black ink is required, the process proceeds to S410, and preliminary discharge is performed on the cap member 13a regardless of the conveyance state of a printing medium. On the other hand, if the preliminary discharge operation of an ink other than the second black ink is required, the process proceeds to S411, and preliminary discharge is performed on the platen absorber 12.

When it is ensured that the printing operation for one page has been completed in S406, the CPU 101 allows the printing medium to be discharged in S412, and the third printing sequence ends in S413.

Thus, the third printing sequence can reduce the amount of waste ink because, whereas the carriage 1 is required to move to the maintenance unit 13 for preliminary discharge of the second black ink, the additional preliminary discharge operation is not required.

The third printing sequence is a printing sequence that can be adopted in a case of a printing medium having high rigidity and a case of a printing medium having a width larger than a predetermined value in the X direction. This is because a printing medium is unlikely to float up in the case of a printing medium having high rigidity or in the case of the printing medium having a width larger than the predetermined value, and the carriage 1 can thus be moved beyond the passing region of the printing medium.

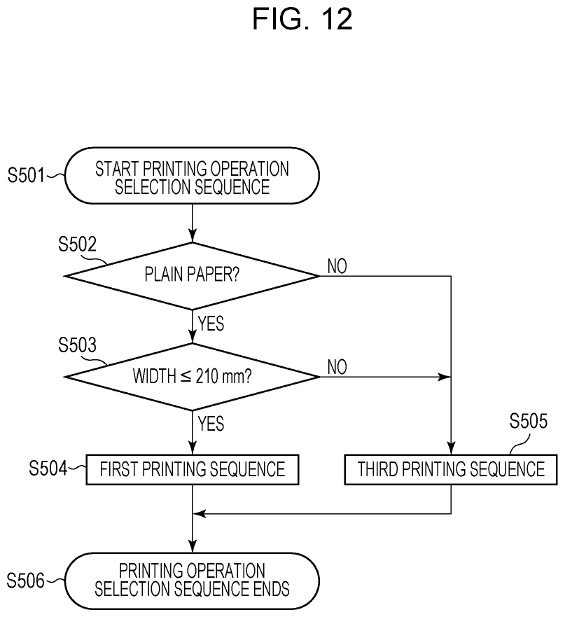

FIG. 12 is a flowchart of a sequence for selecting the first printing sequence or a third printing sequence to be performed. In S501, when the printing apparatus 1000 receives printing data, a printing operation selection sequence is started before a printing sequence is started.

In S502, the CPU 101 determines whether the type of a printing medium is plain paper. The type of a printing medium is determined on the basis of information that a user inputs through an operation panel provided at the printing apparatus 1000 and information included in the printing data to be received.

If the type of a printing medium is plain paper, the process proceeds to S503, and whether the width of the printing medium in the X direction is smaller than or equal to 210 mm is determined. If the width of the printing medium is smaller than or equal to 210 mm, the first printing sequence is selected in S504. The width of the printing medium is determined on the basis of information included in the printing data to be received or determined by detecting edge portions of the printing medium in the X direction by using an optical sensor mounted in the carriage 1.

On the other hand, if a printing medium is not plain paper (that is, a printing medium has high rigidity) or if the width of a printing medium in the X direction is larger than or equal to 210 mm, the process proceeds to S505, and the third printing sequence is selected. The printing operation selection sequence ends in S506.

In the third embodiment, such different preliminary discharge operations of the second black ink are switched on the basis of the rigidity of the printing medium and the width (length) thereof in the X direction. Thus, with respect to a printing medium that does not float up, preliminary discharge of the second black ink is not performed on the platen absorber 12, and the additional preliminary discharge operation is not performed. Therefore, the amount of waste ink can be reduced.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of priority from Japanese Patent Application No. 2019-140192, filed on Jul. 30, 2019, which is hereby incorporated by reference herein in its entirety.

What is claimed is:

1. An inkjet printing apparatus comprising:
a printing head configured to perform a printing operation in which an image is printed by discharging an ink;
a carriage configured to reciprocally move in a first direction with the printing head mounted thereon;
a first roller pair disposed upstream of the printing head in a second direction that intersects the first direction and configured to nip and convey a printing medium in the second direction;
a second roller pair disposed downstream of the printing head in the second direction and configured to nip and convey a printing medium in the second direction;
a first ink receiver disposed inside a printing region in which the printing head performs the printing operation and configured to receive an ink that is discharged from the printing head; and
a second ink receiver disposed outside the printing region and configured to receive an ink that is discharged from the printing head;
wherein the inkjet printing apparatus performs a first printing sequence in which the printing head performs preliminary discharge on the first ink receiver in a first nip state in which a printing medium is nipped by one of the first roller pair and the second roller pair and the printing head performs preliminary discharge on the second ink receiver in a second nip state in which a printing medium is nipped by both the first roller pair and the second roller pair.

2. The inkjet printing apparatus according to claim 1,
wherein, in a first printing mode in which the printing head completes a printing operation for a predetermined region by moving with the carriage in one direction, the inkjet printing apparatus performs a second printing sequence in which the printing head performs preliminary discharge on the second ink receiver in the second nip state and does not perform preliminary discharge in the first nip state, and, in a second printing mode in which the printing head completes the printing operation for the predetermined region by reciprocating with the carriage, the inkjet printing apparatus performs the first printing sequence.

3. The inkjet printing apparatus according to claim 1,
wherein, if a speed of the carriage is larger than a first threshold, the inkjet printing apparatus performs a second printing sequence in which the printing head performs preliminary discharge on the second ink receiver in the second nip state and does not perform preliminary discharge in the first nip state, and, if the moving speed is smaller than the first threshold, the inkjet printing apparatus performs the first printing sequence.

4. The inkjet printing apparatus according to claim 2,
wherein, when a printing operation is performed on a first printing medium, the inkjet printing apparatus performs a third printing sequence in which the printing head performs preliminary discharge on the second ink receiver in any of the first nip state and the second nip state, and, when a printing operation is performed on a second printing medium having lower rigidity than the first printing medium, the inkjet printing apparatus performs the first printing sequence.

5. The inkjet printing apparatus according to claim 2,
wherein, if a length of a printing medium in the first direction is larger than a second threshold, the inkjet printing apparatus performs a third printing sequence in which the printing head performs preliminary discharge on the second ink receiver in any of the first nip state and the second nip state, and, if the length is smaller than the second threshold, the inkjet printing apparatus performs the first printing sequence.

6. The inkjet printing apparatus according to claim 1,
wherein the printing head is capable of discharging a first ink and a second ink that is likely to accumulate compared with the first ink, and
wherein, in the first printing sequence, the printing head performs preliminary discharge of the first ink and the second ink on the first ink receiver in the first nip state and performs preliminary discharge of the first ink on the first ink receiver and preliminary discharge of the second ink on the second ink receiver in the second nip state.

7. The inkjet printing apparatus according to claim 6,
wherein, when the printing head performs preliminary discharge of the second ink on the first ink receiver, after a printing operation has been completed, the printing head performs preliminary discharge of the first ink on a region of the first ink receiver on which the second ink has been discharged.

8. The inkjet printing apparatus according to claim 1, further comprising a platen disposed at a position facing the printing head and configured to support a printing medium,
wherein the first ink receiver is an absorber disposed on an upper surface of the platen.

9. The inkjet printing apparatus according to claim 8,
wherein, when the printing head performs preliminary discharge on the first ink receiver, the printing head discharges to a position away from an edge portion of a printing medium by a predetermined distance in the first direction.

10. The inkjet printing apparatus according to claim 1,
wherein the inkjet printing apparatus is capable of conveying a plurality of printing media that have different lengths in the first direction, the plurality of printing media being conveyed by the first roller pair and the second roller pair so that a center position of each of the plurality of printing media in the first direction passes through the same position.

11. The inkjet printing apparatus according to claim 1,
wherein the second ink receiver is a cap member configured to cover a discharging port surface of the printing head.

12. The inkjet printing apparatus according to claim 11, further comprising a suction unit connected to the cap member.

13. An inkjet printing apparatus comprising:
a printing head configured to perform a printing operation in which an image is printed by discharging an ink;
a carriage configured to reciprocally move in a first direction with the printing head mounted thereon;
a first roller pair disposed upstream of the printing head in a second direction that intersects the first direction and configured to nip and convey a printing medium in the second direction;
a second roller pair disposed downstream of the printing head in the second direction and configured to nip and convey a printing medium in the second direction;
a first ink receiver disposed outside a region through which a printing medium that is conveyed by at least one of the first roller pair and the second roller pair passes and configured to receive an ink that is discharged from the printing head in a state in which at least a portion of the carriage faces the region through which a printing medium passes; and
a second ink receiver configured to receive an ink that is discharged from the printing head in a state in which the entire carriage does not face the region through which a printing medium passes,
wherein the inkjet printing apparatus performs a first printing sequence in which the printing head performs preliminary discharge on the first ink receiver in a first nip state in which a printing medium is nipped by one of the first roller pair and the second roller pair and the printing head performs preliminary discharge on the second ink receiver in a second nip state in which a printing medium is nipped by both the first roller pair and the second roller pair.

14. A control method of an inkjet printing apparatus including a printing head configured to perform a printing operation in which an image is printed by discharging an ink, a carriage configured to reciprocally move in a first direction with the printing head mounted thereon, a first roller pair disposed upstream of the printing head in a second direction that intersects the first direction and configured to nip and convey a printing medium in the second direction, a second roller pair disposed downstream of the printing head in the second direction and configured to nip and convey a printing medium in the second direction, a first ink receiver disposed inside a printing region in which the printing head performs the printing operation and configured to receive an ink that is discharged from the printing head, and a second ink receiver disposed outside the printing region and configured to receive an ink that is discharged from the printing head, the control method comprising:
performing first preliminary discharge on the first ink receiver in a first nip state in which a printing medium is nipped by one of the first roller pair and the second roller pair; and
performing second preliminary discharge on the second ink receiver in a second nip state in which a printing medium is nipped by both the first roller pair and the second roller pair.
